(19) United States
(12) Patent Application Publication
(10) Pub. No.: US 2017/0069306 A1
(43) Pub. Date: Mar. 9, 2017

(54) SIGNAL PROCESSING METHOD AND APPARATUS BASED ON STRUCTURED SPARSITY OF PHONOLOGICAL FEATURES

(71) Applicant: Foundation of the Idiap Research Institute (IDIAP), Martigny (CH)

(72) Inventors: Afsaneh ASAEI, Martigny (CH); Milos Cernak, Martigny (CH); Herve Bourlard, Saxon/VS (CH)

(21) Appl. No.: 14/846,036

(22) Filed: Sep. 4, 2015

(51) Int. Cl. G10L 13/08; G10L 15/25; G10L 25/75; G10L 17/14; G10L 19/00; G10L 25/30; G10L 15/187

(52) U.S. Cl. CPC G10L 13/08; G10L 25/30; G10L 15/25; G10L 15/187; G10L 17/14; G10L 19/0018; G10L 25/75; G10L 2019/0004

(57) ABSTRACT

A multimodal processing method comprising the steps of:
A) Retrieving a data set representing distinctive phonological features;
B) Identifying structured sparse patterns in said data set;
C) Processing said structured sparse patterns.

### FIELD OF THE INVENTION

The present invention concerns a method for signal processing based on estimation of phonological (distinctive) features.

In one embodiment, the invention relates to speech processing based on estimation of phonological (distinctive) features.

### DESCRIPTION OF RELATED ART

Signal processing includes for example speech encoding for compression, speech decoding for decompression, speech analysis (for example automatic speech recognition (ASR), speaker authentication, speaker identification), text to speech synthesis (TTS), or bio-signal analysis for cognitive neuroscience or rehabilitation, automatic assessment of speech signal, therapy of articulatory disorders, among others.

Conventional speech processing methods are based on a phonetic representation of speech, for example on a decomposition of speech into phonemes or triphones. As an example, speech recognition systems using neural networks or hidden Markov models (HMMs) trained for recognizing phonemes or triphones have been widely used. Low bit rate speech coders which operate at phoneme level to achieve a 1-2 kbps bit rate, with an annoying speech degradation, have also been described. Current HMMs text-to-speech (TTS) systems are also based on modelling of phonetic speech segments.

More recently, speech processing methods based on a detection of phonological features have been suggested by Simon King and Paul Taylor in “detection of phonological features in continuous speech using neural networks”, Computer speech and language, vol. 14, n° 4, pp. 333-353, October 2000.

In this approach, phonological features describing the status of the speech production system are identified and processed, instead of phonetic features. Phonological features can be used for speech sound classification. For example, a consonant [j] is articulated using the mediodorsal part of the tongue [+Dorsal class], in the motionless, mediopalatal, part of the vocal tract [+High class], generated with simultaneous vocal fold vibration [+Voiced class].

Phonological features are considered as sub-phonetic, i.e., their composition is required to represent/model a phoneme. Using the phonological features for speech analysis and syntesis is motivated by theorethical works of C. P. Browman and L. M. Goldstein, “Towards an articulatory phonology”, Phonology 3, May 1986, pp. 219-252, and A. M. Liberman and D. H. Whalen, “On the relation of speech to language”, Trends in cognitive sciences 4 (5), May 2000, pp. 187-196. The authors claim that basic speech elements are articulatory gestures, extended by linguists as phonological (distinctive) features, which are the primary objects of both speech production and perception.

Speech signal based phonological features have been used for example in automatic speech recognition and automatic language identification.

However, since the number of phonological features which is required to describe a speech sample is relatively high (and the time courses of the features overlap and they are redundant), the benefits of this phonological approach remained so far limited. As an example, the bit rates achieved by known phonological encoders have been higher than bit rates achieved by conventional vocoders based on a phonetic analysis of speech.

Further compression gains have been obtained by pruning the phonological features smaller than a certain (empirically tuned) threshold to attain higher compression. Although this pruning scheme seems to be effective, it is not suitable for codec implementation as it introduces bursts of features and highly variable code length that could impact the latency of speech coding.

### BRIEF SUMMARY OF THE INVENTION

It is therefore an aim of the present invention to provide a signal processing method based on an estimation of phonological features which is more efficient than conventional methods. According to the invention, these aims are achieved by means of a method where the structured sparsity of the phonological features is used.

In other words, “hidden” patterns in set of phonological features are identified and used to achieve a more efficient speech coding or novel multimedia and bio-signal processing methods.

This method can lead to novel video processing and bio-signal processing methods based on an estimation of phonological features.

A representation of N phonological features is said to be k-sparse if only k<<N entries have non zero values.

In one aspect, the invention is thus related to a signal processing method comprising the steps of:
A) Retrieving a binary or multivalued (quantized) data set representing distinctive phonological features;
B) Identifying structured sparse patterns in said data set;
C) Processing said structured sparse patterns.

In one aspect, the invention is related to the use of sparsity in phonological features. Phonological features are:
(1) sparse: since production of speech frame at each time instant involves very few of the articulatory components; and
(2) structured sparse: since the articulatory components are activated in groups to collaboratively produce a linguistic unit.

The signal may be a speech signal, a video (including e.g. lip movements), or a bio-signal (such as e.g. EEG recordings).

Phonological features are indicators of the physiological posture of the human articulation machinery. Due to the physical constraints, only few combinations can be realized in our vocalization. This physical limitation leads to a small number of unique patterns exhibited over the entire speech corpora, and thus to sparsity at a frame level. We refer to this structure as physiological structure. In addition, there is a block (repeated) structure underlying a sequence of phonological features. This structure is exhibited at the supra-segmental level by analysing along duration of the features. This structure is associated to the syllabic information underlying a sequence of phonological features. We refer to this structure as semantic structure, and results in higher level sparsity.

The phonological features may comprise major class features, laryngeal features, manner features, and/or place features.

Other phonological systems may be used, including Chomsky's system with features, multi-valued systems, Governement Phonology feature systems, and/or systems exploiting pseudo-phonological features.

The phonological features may be specified by univalent or multi values to signify whether a segment is described by the feature.

The identification of structured sparse patterns may use a predefined codebook of structured sparse patterns.

The step of retrieving the data set may include a step of extracting this data set from a signal sample such as speech, video (e.g. lip movement), or bio-signals (e.g. EEG recordings).

The speech processing may include encoding. A phonological representation of speech is more suitable and more compact than a phonetic representation, because:

the span of phonological features is wider than the span of phonetic features, and thus the frame shift could be higher, i.e., fewer frames are transmitted yielding lower bit rates;

the binary nature of phonological features promises to achieve a higher compression ratio;

phonological features are inherently multilingual. This in turn has an advantage in the context of multilingual vocoding without the need for a phonetic decision.

The speech processing may comprise a structured compressive sampling of said sparse patterns. Structured compressive sampling relies on a sparse representation of the structured sparse patterns. Reconstruction from the compressed samples may use very few linear non adaptive observations.

According to one aspect, the invention is thus related to a structured compressive sampling method to provide a low-dimensional projection of these features, relying on structured sparsity of phonological features. This approach leads to fixed length codes for transmission so it is very convenient for codec implementation.

The speech processing may include an event analysis for analysing events in the signal. The event analysis may include a speech parametrization (such as formants, LPC, PLP, MFCC features) or visual clue extraction (such as a shape of mouths) or brain-computer interface feature extraction (such as electroencephalogram patterns) or ultrasound and optical camera and electromagnetic signals input of tongue and lip movements or electromyography of speech articulator muscles and the larynx.

According to one aspect, sparse phonological features are reconstructed from structured compressed sampled features, using any suitable sparse recovery algorithm.

Structured compressive sampling (also known as compressed sensing, compressive sensing or sparse sampling) and reconstruction from compressive sampling is known as such. The following documents suggest the use of structured compressive sampling in the context of speech compression:

U.S. Pat. No. 8,553,994 discloses a compressive sampler configured to receive sparse data from an encoder that processes video, images or audio numerical signals.

US2014337017 discloses an automatic speech recognition method comprising a step of compressive sensing for source noise reduction.

US2014195200 points out that sparse sampling could reduce the amount of data arising from sparse representations that are popular in speech signal processing.

However, none of those documents suggests the use of structured compressive sampling for compressing a set of phonological features.

In one aspect, the signal processing includes speech processing.

In one aspect, the speech processing may include speech analysis.

The speech analysis may include speech recognition or speaker identification or authentication.

The speech processing may include speech synthesis or speech decoding.

In another aspect, multimedia and bio-signal processing methods can be devised exploiting the structured sparsity of phonological features.

### BRIEF DESCRIPTION OF THE DRAWINGS

The invention will be better understood with the aid of the description of an embodiment given by way of example and illustrated by the figures, in which:

FIG. 1 schematically illustrates a speech analysis (encoding) device based on phonological features according to the invention.

FIG. 2 schematically illustrates a speech synthesis (decoding) device based on phonological features according to the invention.

### DETAILED DESCRIPTION OF POSSIBLE EMBODIMENTS OF THE INVENTION

In one aspect, the invention is related to a speech coding apparatus and to a speech coding method using structured compressive sampling for generating a compressed representation of a set of phonological features.

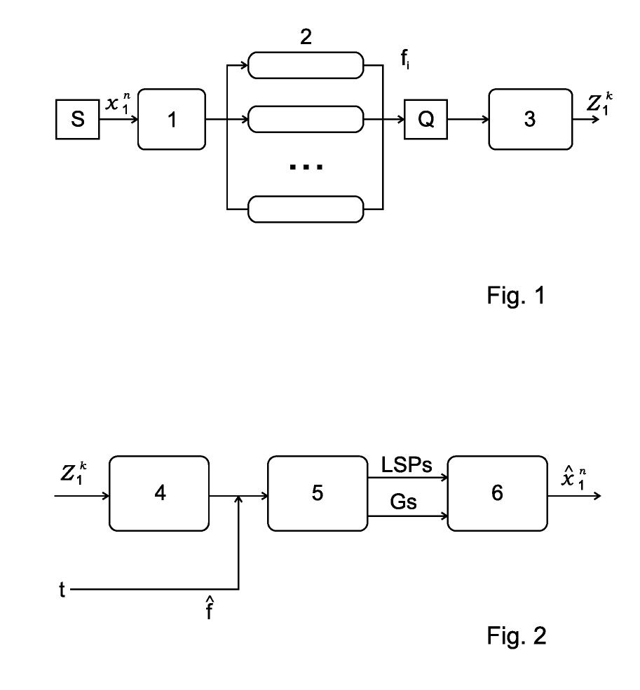

We will now describe, as an example, a signal coding system and method relying on the compressibility of the phonological representation of a signal, and using structured compressive sampling to reduce the dimension of the phonological features. FIG. 1 shows the functional blocks of a signal encoding device. FIG. 2 shows the block of a corresponding decoding device.

In this example, we consider a speech signal only, for example a speech signal being present in a multi-modal input.

The encoding device of FIG. 1 comprises an event analysis module 1 or a signal analysis module 1 for analysing a signal s, such as a speech signal, a video signal, a brain signal, an ultrasound and/or optical camera and electromagnetic signals representative of tongue and lip movements, or an electromyography signal representative of speech articulator muscles and of the larynx. One or a plurality of features identification modules 2 retrieve a data set representing distinctive phonological features in this sample. A quantifying module Q quantifies this data set into binary or multivalued values. A structured compressive sampling block 3 identifies structured sparse patterns in this data set, and process those structured sparse patterns, in order to generate a representation z₁^{k} of the feature with a reduced volume of the data.

On FIG. 2, transmitted compressed features z₁^{k} are recovered at the receiver side where a sparse recovery module 4 reconstructs the data set. A phonological decoder 5 generates the speech parameters for speech re-synthesis by a speech synthesis module 6. The speech synthesis module delivers synthesized digital speech samples.

Alternatively, the synthesis module of FIG. 2 can act as a phonological text-to-speech (TTS) system. In this case, a text t is used as the input of the phonological decoder 5 instead of phonological features reconstructed by the sparse recovery module 4. The text is converted to a sequence of phonemes, and the sequence of phonemes is converted into a canonical binary phonological representation of the text f.

The feature identification module 2 may use different type of phonological features for classifying the speech. In one embodiment, a phonological feature system is used where following groups of features are used: major class features, laryngeal features, manner features, and place features.

In this system, major class features represent the major classes of sounds (syllabic segments; consonantal segments; approximant segments; sonorant segments; etc). Laryngeal features specify the glottal states of sounds (for example to indicate whether vibration of the vocal folds occur; to indicate the openess of the glottis; etc). Manner features specify the manner of articulation (passage of air through the vocal tract; position of the velum; type of friction; shape of the tongue with respect of the oral tract; etc). Place features specify the place of articulation (labial segments that are articulated with the lips; lip rounding; coronal sounds; anterior segments articulated with the tip of the tongue; dorsal sounds articulated by raising the dorsum of the tongue; etc).

Other systems may be used for describing and classifying phonological features, including for example the Jacobsonian system proposed by Jakobson & Halle (1971).

The feature identification modules 2 thus deliver a data set of features fᵢ, i.e. features values which may be specified by binary or multivalued coefficients to signify whether a speech segment is described by the feature.

In the application to a speech coding system, this quantized set of features fᵢ is compressed by the structured compressive sampling block 3, exploiting the structured sparsity of features. Structured compressive sampling relies on structured sparse representation to reconstruct a high-dimensional data using very few linear nonadaptive observations.

A data representation α∈ [symbol] ^{N} is K-sparse if only K<<N entries of α have non zero values. We call the set of indices corresponding to the non-zero entries as the support of α.

In the structured compressive sampling block 3, the choice of structured compressive measurement matrix D is preferably such that all pairwise distances between K-sparse representations must be well preserved in the observation space or equivalently all subsets of K columns taken from the measurement matrix are nearly orthogonal. This condition on the compressive measurement matrix is referred to as the restricted isometry property (RIP). In one embodiment, random matrices D are generated by sampling from Gaussian or Bernoulli distributions; those matrices are proved to satisfy the RIP condition.

To generate D in the Gaussian case, we generate samples from a multivariate Gaussian distribution. On the other hand, we can create a structured binary matrix D by setting around 50% of the components of each column at structured or random permutations to 1. Test have shown that the choice of Bernoulli matrix achieves higher robustness to quantization.

The structured sparsity of the phonological features enables the construction of a codebook for very efficient coding in the module 3. To this end, phonological features fᵢ that have been shown to be efficient for very low bit rate speech coding are preferably used.

Additional compression can be achieved by exploiting the structured sparsity of the phonological features fᵢ. The intuition is that the phonological features lie on low-dimensional subspaces. The low-dimension pertain to either physiology of the speech production mechanism or the semantic of the supra-segmental information.

Indeed, at the physiology level, only certain (very few) combinations of the phonological features can be realized through human vocalization. This property can be formalized by constructing a codebook of structured sparse codes for phonological feature representation.

Likewise, at the semantic level, only certain (very few) supra-segmental (e.g. syllabic) mapping of the sequence of phonological features is linguistically permissible. The sparse structures of phonological features at supra-segmental level are indicators of human perception and understanding of higher level speech information such as stress and emotion. This property can be exploited for block-wise coding of these features with a slower (supra-segmental) dynamic.

The use of compressive sampling both at the physiology level and at semantic level thus encapsulates speech information at different time scales from short frames to supra-segmented information in a unified efficient coding framework.

Experiments have shown that structured sparse coding of the binary features enables the codec to operate at 700 bps without imposing any latency or quality loss with respect to the earlier developed vocoder. By considering a latency of about 256 ms, the bit rate of 250-350 bps is achieved without requirement for any prior knowledge on supra-segmental (e.g. syllabic) identities.

In one experiment, the phonological features generated for an audiobook with the length of 21 hours speech have been used. The total number of unique structures emerging out of total number of 4746186 frames is only 12483 which is about 0.26% of the whole features. By identifying all the unique structures, a codebook is constructed for phonological feature representation. Only 14 bits are enough for transmitting a code. Given that the number of frames per second for phonological vocoding is 501, this coding scheme leads to 50×14=700 bits per second transmission rate. Furthermore, from a supra-segmental view, there is strong correlation between the adjacent features due to limited permissible linguistic combinations. The supra-segmental linguistic units may correspond to the syllabic identities or stressed regions. While exploiting the supra-segmental information has been shown to yield significant bit-rate reduction, in practice, providing the syllabic information requires additional processing which can impose higher cost on the codec. On the other hand, constructing a codebook of structured sparse patterns as described above requires less analysis.

The supra-segmental information can be captured by imposing a latency and transmitting the blocks repeated patterns. As a case study, investigating the features obtained for the audiobook reveals that the number of blocks is less than 36% of the total number of frames and 4 bits is sufficient to transmit the number of repeated codes. That amounts to 0.36×50×(14+4)=328 bps transmission rate with no loss in the quality of the reconstructed speech. If the duration information is dropped, then the bitrate is only 250 bps; further analysis is required to evaluate the extent of distortion that ignoring the temporal duration can impose on ineligibility of the reconstructed speech.

At the decoder, and given the compressed codes, there are infinitely many solutions to reconstruct in module 4 the original high-dimensional representation. Relying on the two principles of (1) sparse representation and (2) incoherent measurement, we can circumvent the ill-posedness of the problem and recover the K-sparse data stably from the compressed (low dimensional) observations through efficient optimization algorithms which search for the sparsest representation that agrees with those observations.

The high-dimensional phonological features may be reconstructed by module 4 using any sparse recovery algorithm. One example is expressed as

$$\hat{α} = arg min {‖ α ‖}_{1} + λ {‖ z - D α ‖}_{2}$$

$$subject to 0 < α < 1$$

where λ A is the regularization parameters. The first term ∥·∥1 is a relaxed (convex) version of the l0 semi-norm sparse recovery problem. This term promotes the sparsity of the recovered representation. This term can be replaced by ∥·∥∞ standing for the l∞-norm defined as the maximum component of α. It is shown that l∞-norm leads to de-quantization effect.

The second term of the equation accounts for the reconstruction error. Regularization on the l2−-norm is equivalent to the solving the constrained optimization, 0=Dα if the measurements are not quantized. The constraint 0<α<1 is set for the phonological features as they are neural network estimated posterior probabilities for each individual phonological class.

Having the prior knowledge of the bound of the features eliminates the need for l∞-norm.

In the phonological decoder 5, a DNN (deep neural network) may be used to learn the highly-complex regression problem of mapping phonological features to speech parameters for re-synthesis. The DNN maps phonological features posteriors to speech parameters-line spectra and glottal signal parameters. While phonological encoders are speaker-independent, the phonological decoder 5 is preferably speaker dependent because of speaker dependent speech parameters. To this end, the DNN may be trained with speaker dependent phonological data set and speech samples. The DNN may be trained on a target voice without transcriptions, in a semisupervised manner.

Finally, speech is re-synthesised in the speech synthesis module 6 using any speech vocoder system (such as LPC re-synthesis).

The sparse properties of phonological features may also be used

for applications other than speech compression and speech reconstruction.

In one example, the identified structured sparse patterns in a binary data

set of phonological features are used for classification, for example in an

automatic speech recognition system or speaker authentication/identification

system; each speech content or speaker is associated with a

unique set of structured sparse patterns. Structured sparse patterns may

also be used in applications such as cognitive science, rehabilitation, speech

assessment and therapy of articulatory disorders, silent speech interfaces, etc.

The various operations of methods described above may be performed by any suitable means capable of performing the operations, such as various hardware and/or software component(s), circuits, and/or module(s). Generally, any operations described in the application may be performed by corresponding functional means capable of performing the operations. The various means, logical blocks, and modules may include various hardware and/or software component(s) and/or module(s), including, but not limited to a circuit, an application specific integrated circuit (ASIC), or a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein.

The steps of a method or algorithm described in connection with the present disclosure may be performed by various apparatuses, including without restriction computers, servers, smartphones, PDAs, smart watches, codecs, modems, connected devices, wearables devices, etc. The invention is also related to such an apparatus arranged or programmed for performing those steps.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A software module may consist of an executable program, a portion or routine or library used in a complete program, a plurality of interconnected programs, an “apps” executed by many smartphones, tablets or computers, a widget, a Flash application, a portion of HTML code, etc. A storage medium may be coupled to a processor such that the processor can read information from, and write information to, the storage medium. In the alternative, the storage medium may be integral to the processor. A database may be implemented as any structured collection of data, including a SQL database, a set of XML documents, a semantical database, or set of information available over an IP network, or any other suitable structure.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

It is to be understood that the claims are not limited to the precise configuration and components illustrated above.

As used herein, the term “retrieving” encompasses a wide variety of actions. For example, “retrieving” may include receiving, reading, calculating, computing, processing, deriving, investigating, looking up (e.g., looking up in a table, a database or another data structure), accessing, ascertaining, estimating and the like.

As used herein, the term “identifying” encompasses a wide variety of actions. For example, “identifying” may include calculating, computing, processing, deriving, investigating, looking up (e.g., looking up in a table), evaluating, estimating and the like.

Various modifications, changes and variations may be made in the arrangement, operation and details of the methods and apparatus described above without departing from the scope of the claims.

1. A signal processing method comprising the steps of:
A) Retrieving a data set representing phonological features;
B) Identifying structured sparse patterns in said data set;
C) Processing said structured sparse patterns.

2. The method of claim 1, said signal being a speech signal, said phonological features comprising major class features, laryngeal features, manner features, and place features.

3. The method of claim 1, wherein said features are specified by binary or univalent or multi-valued quantized values to signify whether a segment is described by the feature.

4. The method of claim 1, wherein the identification of structured sparse patterns uses a codebook of structured sparse patterns.

5. The method of claim 4, wherein the identification of structured sparse patterns uses a first said codebook of structured sparse patterns at physiology level.

6. The method of claim 4, wherein the identification of structured sparse patterns uses a second said codebook of structured sparse patterns at supra-segmental level.

7. The method of claim 1, wherein retrieving said data set includes extracting said data set from any combination of at least one among a speech signal, a video signal, a brain signal, an ultrasound signal representative of the tongue and/or lip movement, an optical camera signal representative of the tongue and/or lip movement, and/or an electromyography signal representative of speech articulator muscles and of the larynx.

8. The method of claim 7, wherein said signal processing includes phonological encoding.

9. The method of claim 8, wherein said signal processing comprises a structured compressive sampling of said data sets.

10. The method of claim 7, wherein said signal processing includes event analysis.

11. The method of claim 10, wherein said event analysis includes speech parametrization (such as formants, LPC, PLP, MFCC features) or visual clue extraction (such as a shape of mouths) or brain-computer interface feature extraction (such as electroencephalogram patterns) or extraction of feature from an ultrasound, optical or electromyography signal representative of the tongue and/or lip and/or speech articulator muscles and/or larynx movement or position.

12. A multimodal signal processing method comprising the steps of:
C) Retrieving phonological features;
D) Reconstructing uncompressed phonological features;
E) Synthesising speech parameters from said reconstructed uncompressed phonological features.

13. The method of claim 12, wherein said speech parameters include speech excitation and vocal tract, cepstral parameters.

14. The method of claim 12, wherein a deep neural network is used for mapping the uncompressed phonological features to speech parameters for re-synthesis.

15. The method of claim 12, comprising a step of creating said uncompressed phonological features from a text.

16. A multimodal signal processing apparatus comprising:
an event analysis module;
a feature identification module for retrieving a data set representing phonological features;
a processing module for identifying structured sparse patterns in said data set, and for processing said structured sparse patterns.

17. The multimodal signal processing apparatus of claim 16, said processing module being a structured compressive sampling module.

18. A multimodal signal processing apparatus comprising:
a sparse recovery module for receiving a digital signal and reconstructing a data set representing phonological features;
a phonological decoder for generating speech parameters;
a speech synthesis module for receiving said speech parameters and delivering estimated digital speech samples, or for converting text to canonical binary phonological features and delivering digital speech samples.

19. The apparatus of claim 18, said phonological decoder outputting line spectra and glottal signal parameters.

20. The apparatus of claim 18, said speech synthesis module comprising a deep neural network trained for mapping phonological features to speech parameters.

21. The apparatus of claim 18, said speech synthesis module being speaker dependant.
